(19) United States
(12) Patent Application Publication
(10) Pub. No.: US 2026/0145544 A1
(43) Pub. Date: May 28, 2026

(54) MACHINE POSITION SENSOR DATA PROCESSING METHOD AND SYSTEM

(71) Applicant: GM GLOBAL TECHNOLOGY OPERATIONS LLC, Detroit, MI (US)

(72) Inventors: Vinod Chowdary Peddi, Shelby Township, MI (US); Tanvi Nagarale, Rochester Hills, MI (US); Brian J. Gallert, Lake Orion, MI (US)

(73) Assignee: GM GLOBAL TECHNOLOGY OPERATIONS LLC, Detroit, MI (US)

(21) Appl. No.: 18/956,555

(22) Filed: Nov. 22, 2024

(51) Int. Cl. B60L 15/00; B60L 50/51; B60L 50/60; G01B 7/30

(52) U.S. Cl. CPC B60L 15/007; B60L 50/51; B60L 50/60; G01B 7/30; B60L 2210/44

(57) ABSTRACT

A system for determining an angular position of a rotor within an electric motor including a resolver for generating a first alternating current and a second alternating current in response to a rotation of the rotor and a position filter for performing a synchronous frame filtering on the first alternating current and the second alternating current to generate a first angular position, performing a motion state filtering on the first angular position to determine a first rotational angle and a second rotational angle, and performing a harmonic error decoupling on the first angular position in response to the first rotational angle and the second rotational angle to generate a refined angular position.

### INTRODUCTION

The present disclosure generally relates to vehicles, systems and methods for object rotational machine position detection in an automotive system. In particular, a method is disclosed for a generalized approach to compensating for non-ideal position sensor behavior in alternating current (AC) machines.

Autonomous and semi-autonomous vehicles are capable of sensing their environment and navigating based on the sensed environment. Such vehicles sense their environment using sensing devices such as radar, lidar, image sensors, and the like. The vehicle system further uses information from global positioning systems (GPS) technology, navigation systems, vehicle-to-vehicle communication, vehicle-to-infrastructure technology, and/or drive-by-wire systems to navigate the vehicle. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Position sensors are components in autonomous and semi-autonomous automotive systems, offering information about the position of various mechanical elements. These sensors play a pivotal role in optimizing vehicle performance, enhancing safety features, and enabling advanced driver-assistance systems (ADAS). By accurately measuring linear or rotational displacement, position sensors provide real-time data to the vehicle's control units. This data is utilized to control engine timing, throttle position, steering angle, and numerous other functions. For instance, a throttle position sensor measures the driver's input to the accelerator pedal, enabling the engine control module to adjust fuel injection and ignition timing accordingly. Similarly, a crankshaft position sensor measures the rotational position of the crankshaft, which is used for determining engine speed and timing.

Several types of position sensors are commonly employed in automotive applications, each with its own advantages and limitations. Potentiometers, Hall-effect sensors, and magneto-resistive sensors are among the most prevalent. Potentiometers utilize a resistive element and a wiper to measure position, while Hall-effect sensors detect changes in magnetic fields. Magneto-resistive sensors, on the other hand, exploit changes in electrical resistance in response to a magnetic field. The widespread adoption of position sensors has significantly contributed to the advancement of automotive technology. These sensors are integral to the operation of safety systems such as anti-lock braking systems (ABS) and electronic stability control (ESC). Additionally, they enable the development of fuel-efficient engines, advanced driver-assistance systems, and autonomous driving technologies. As the automotive industry continues to innovate, position sensors will remain crucial in shaping the future of vehicle technology.

Furthermore, position sensors are used for enabling ADAS and autonomous driving technologies. These systems rely on accurate and reliable position data to make informed decisions about vehicle control and navigation. For example, a steering angle sensor provides information about the driver's steering input, allowing the vehicle's control systems to adjust stability control and lane-keeping assistance. Additionally, wheel speed sensors measure the rotational speed of each wheel, which is used for anti-lock braking systems and traction control. Accordingly, it is desirable to provide systems and method for detecting images with close, high and rare objects, for building an image corpus for object detection. Furthermore, other desirable features and characteristics of the present invention will become apparent from the subsequent detailed description and the appended claims, taken in conjunction with the accompanying drawings and the foregoing technical field and background.

### SUMMARY

Disclosed herein are vehicle system propulsion methods and systems and related control logic for provisioning vehicle propulsion systems, methods for making and methods for operating such propulsion systems, and motor vehicles equipped with propulsion systems. By way of example, and not limitation, there are presented various embodiments of systems for providing an electric motor positing sensor and an electric motor position processing system for compensating for non-ideal position sensor behavior in alternating current machines in a motor vehicle disclosed herein.

In accordance with an aspect of the present disclosure, a method of determining an angular position of an electric motor includes receiving, from a sensor, a first alternating current and a second alternating current sensed in response to a rotation of a rotor within the electric motor wherein the first alternating current is ninety degrees phase shifted from the second alternating current, performing a synchronous frame filtering on the first alternating current and the second alternating current to generate a first angular position, performing a motion state filtering on the first angular position to determine a first rotational angle and a second rotational angle, performing a harmonic error decoupling on the first angular position in response to the first rotational angle and the second rotational angle to generate a refined angular position, and controlling an inverter to generate a three phase alternating current in response to the refined angular position, controlling the electric motor in response to the three phase alternating current, and propelling a vehicle along a motion path with the electric motor.

In accordance with another aspect of the present disclosure, wherein the motion state filtering is operative to interpolate between a plurality of discrete values of the first alternating current and the second alternating current to generate the first angular position.

In accordance with another aspect of the present disclosure, wherein the refined angular position forms a value in a refined first refined alternating current and a second refined alternating current and wherein the first refined alternating current and a second refined alternating current are supplied to an inverter controller for controlling the inverter to modify a characteristic of the three phase alternating current.

In accordance with another aspect of the present disclosure, wherein the harmonic error decoupling is configured to transform the first rotational angle and the second rotational angle to a rotating reference frame in order to mitigation a high-frequency quantization noise and a plurality of harmonic distortions.

In accordance with another aspect of the present disclosure, wherein the sensor is a resolver and wherein the first alternating current is a quantized value of a sine wave current and the second alternating current is a quantized value of a cosine wave current.

In accordance with another aspect of the present disclosure, wherein the synchronous frame filtering further includes reducing a frequency of the first alternating current to zero to obtain a first direct current (DC) value and reducing a frequency of the second alternating current to zero to obtain a second DC value and wherein the first DC value and the second DC value are passed through a low pass filter to remove a high frequency component from the first DC value to generate a first filtered DC value and a second filtered DC value and wherein the first angular position is determined in response to the first filtered DC value and the second filtered DC value.

In accordance with another aspect of the present disclosure, wherein the motion state filtering is further configured to detect a first angle error and a second angle error in response to the first angular position and to extract a high frequency component from the first angle error to generate the first rotational angle and to extract a low frequency component from the second angle error to generate the second rotational angle.

In accordance with another aspect of the present disclosure, wherein the motion state filtering is further configured to filter a plurality of harmonic distortions from the first angular position to determine the first rotational angle and the second rotational angle.

In accordance with another aspect of the present disclosure, wherein the second rotational angle is coupled back to the synchronous frame filtering and where the second rotational angle is used to generate a subsequent angular position in response to a subsequent first alternating current and a second subsequent alternating current.

In accordance with another aspect of the present disclosure, a system for determining an angular position of a rotor within an electric motor includes a sensor for generating a first alternating current and a second alternating current, a position filter for performing a synchronous frame filtering on the first alternating current and the second alternating current to generate a first angular position, performing a motion state filtering on the first angular position to determine a first rotational angle and a second rotational angle, performing a harmonic error decoupling on the first angular position in response to the first rotational angle and the second rotational angle to generate a refined angular position, an inverter controller for controlling an inverter to generate a three phase alternating current in response to the refined angular position, and the electric motor for propelling a vehicle in response to the three phase alternating current.

In accordance with another aspect of the present disclosure, wherein the refined angular position forms a value in a refined first refined alternating current and a second refined alternating current and wherein the first refined alternating current and a second refined alternating current are supplied to the inverter controller for controlling the inverter to modify a characteristic of the three phase alternating current.

In accordance with another aspect of the present disclosure, wherein the position filter is further configured to interpolate between a plurality of discrete values of the first alternating current and the second alternating current to generate the first angular position.

In accordance with another aspect of the present disclosure, wherein the position filter is further configured to transform the first rotational angle and the second rotational angle to a rotating reference frame in order to mitigation a high-frequency quantization noise and a plurality of harmonic distortions.

In accordance with another aspect of the present disclosure, wherein the sensor is a resolver and wherein the first alternating current is a quantized value of a sine wave current and the second alternating current is a quantized value of a cosine wave current and wherein the first alternating current and the second alternating current are generated in response to a rotation of the rotor.

In accordance with another aspect of the present disclosure, wherein the position filter is further configured for reducing a frequency of the first alternating current to zero to obtain a first DC value and reducing a frequency of the second alternating current to zero to obtain a second DC value and wherein the first DC value and the second DC value are passed through a low pass filter to remove a high frequency component from the first DC value to generate a first filtered DC value and a second filtered DC value and wherein the first angular position is determined in response to the first filtered DC value and the second filtered DC value.

In accordance with another aspect of the present disclosure, wherein the position filter is further configured to detect a first angle error and a second angle error in response to the first angular position and to extract a high frequency component from the first angle error to generate the first rotational angle and to extract a low frequency component from the second angle error to generate the second rotational angle.

In accordance with another aspect of the present disclosure, wherein the position filter is further configured to filter a plurality of harmonic distortions from the first angular position to determine the first rotational angle and the second rotational angle.

In accordance with another aspect of the present disclosure, wherein the second rotational angle is used to generate a subsequent angular position in response to a subsequent first alternating current and a second subsequent alternating current in response to a subsequent synchronous frame filtering.

In accordance with another aspect of the present disclosure, an electric vehicle propulsion system including a battery for supplying a DC current, an inverter for converting the DC current to a three phase alternating current (AC) current in response to an inverter control signal, an electric motor for rotating a rotor within the electric motor in response to the three phase AC current, a resolver for generating a first alternating current and a second alternating current in response to a rotation of the rotor, a position sensor for performing a synchronous frame filtering on the first alternating current and the second alternating current to generate a first angular position, performing a motion state filtering on the first angular position to determine a first rotational angle and a second rotational angle, performing a harmonic error decoupling on the first angular position in response to the first rotational angle and the second rotational angle to generate a refined angular position, and an inverter controller for generating the inverter control signal in response to the refined angular position.

In accordance with another aspect of the present disclosure, wherein the synchronous frame filtering further includes reducing a frequency of the first alternating current to zero to obtain a first DC value and reducing a frequency of the second alternating current to zero to obtain a second DC value and wherein the first DC value and the second DC value are passed through a low pass filter to remove a first high frequency component from the first DC value to generate a first filtered DC value and a second filtered DC value and wherein the first angular position is determined in response to the first filtered DC value and the second filtered DC value and wherein the motion state filtering is further configured to detect a first angle error and a second angle error in response to the first angular position and to extract a second high frequency component from the first angle error to generate the first rotational angle and to extract a low frequency component from the second angle error to generate the second rotational angle and, wherein the harmonic error decoupling is configured to transform the first rotational angle and the second rotational angle to a rotating reference frame in order to mitigation a high-frequency quantization noise and a plurality of harmonic distortions.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous or semi-autonomous vehicle system utilizing an alternating current (AC) machine position sensor data processing method, in accordance with various embodiments;

FIG. 2 is a functional block diagram illustrating exemplary EV drive system that includes the AC machine position sensor data processing method, in accordance with various embodiments;

FIG. 3 is a system diagram illustrating an exemplary block diagram of a position sensor indicative of the AC machine position sensor data processing method, in accordance with various embodiments; and

FIG. 4 is a data flow diagram schematically representing a flow chart indicative of a method for performing an AC machine position sensor data processing method, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods described herein provide a robust object detection system by creating a corpus of images for use by training object detectors that focuses on close, tall and rare objects, in a long-tailed distribution, such as objects that are less frequently observed. In the automotive domain, common objects such as vehicles, pedestrians, and road signs are routinely encountered. The disclosed method uses relative depth, eye gaze estimation and frequent object detection to find images with high, close and rare objects, without using specific queries or rare object detectors to find such frames. In particular, the systems and methods are proposed using a two-stage approach to detect and classify rare, proximate, and tall objects within an image. The initial stage employs a combination of gaze estimation and depth estimation techniques to identify potential regions of interest. This stage prioritizes geometric and salient cues, rather than semantic object recognition. Subsequently, a frequent object detector is applied to these regions. By comparing the detected objects against a database of common objects, the system can effectively isolate rare instances that may signify unusual or uncommon scenarios. This approach enables the detection of anomalous objects that may pose potential risks to autonomous vehicle systems.

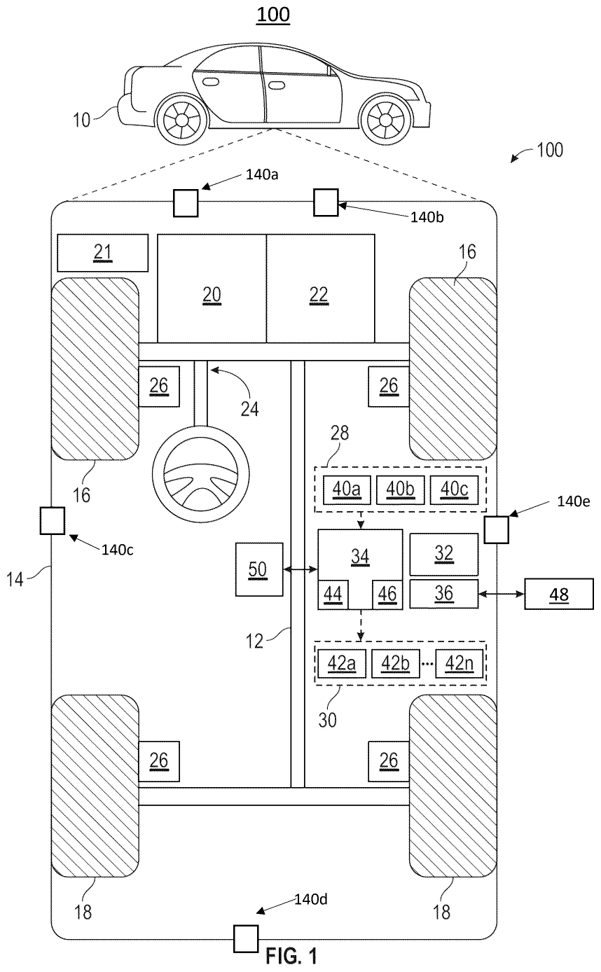

With reference to FIG. 1, a vehicle system shown generally at 100 is associated with a vehicle 10 in accordance with various embodiments. In general, the vehicle system 100 includes an object detection system 200 that is configured to detect locations of static, dynamic, common and uncommon proximate objects. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In some embodiments, the vehicle 10 is an autonomous vehicle and the static object detection system 200 is incorporated into the autonomous vehicle 10 (hereinafter referred to as the autonomous vehicle 10). The present description concentrates on an exemplary application in autonomous vehicle applications. It should be understood, however, that the static object detection system 200 described herein is envisaged to be used in semi-autonomous automotive vehicles.

The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras 140a-140n, thermal cameras, ultrasonic sensors, and/or other sensors. The optical cameras 140a-140n are mounted on the vehicle 10 and are arranged for capturing images (e.g. a sequence of images in the form of a video) of an environment surrounding the vehicle 10. In the illustrated embodiment, there are two front cameras 140a, 140b arranged for respectively imaging a wide angle, near field of view and a narrow angle, far field of view. Further illustrated are left-side and right-side cameras 140c, 140e and a rear camera 140d. The number and position of the various cameras 140a-140n is merely exemplary and other arrangements are contemplated.

The sensor system 28 includes one or more of the following sensors for use in detecting locations of static, dynamic, common and uncommon proximate objects. The sensor system 28 may include a steering angle sensor (SAS), a wheel speed sensor (WSS), an inertial measurement unit (IMU), a global positioning system (GPS), an engine sensor, and a throttle and/or brake sensor. The sensor system 28 provides a measurement of translational speed and angular velocity in the input vector 204.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in automatically controlling the autonomous vehicle 10. In various embodiments, the data storage device 32 stores defined maps of the navigable environment. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as programmable read-only memory (PROM), electrically PROM, electrically erasable PROM, flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the object detection system 200 and, when executed by the processor 44, are configured to implement the methods and systems described herein for detecting locations of static, dynamic, common and uncommon proximate objects.

The communication system 36 is configured to wirelessly communicate information to and from other entities 48, such as but not limited to, other vehicles, infrastructure, remote systems, and/or personal devices. In an exemplary embodiment, the communication system 36 is a wireless communication system configured to communicate via a wireless local area network (WLAN) or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

As can be appreciated, the subject matter disclosed herein provides certain enhanced features and functionality to what may be considered as a standard or baseline autonomous vehicle 10. To this end, an autonomous vehicle can be modified, enhanced, or otherwise supplemented to provide the additional features described in more detail below. The subject matter described herein concerning the static object detection system 200 is not just applicable to autonomous driving applications, but also other driving systems having one or more automated features utilizing automatic traffic object detection, particularly the location of static traffic objects to control an automated feature of the vehicle 10.

In accordance with an exemplary autonomous driving application, the controller 34 implements an autonomous driving system 70. That is, suitable software and/or hardware components of the controller 34 (e.g., the processor 44 and the computer-readable storage device 46) are utilized to provide an autonomous driving system 70 that is used in conjunction with vehicle 10.

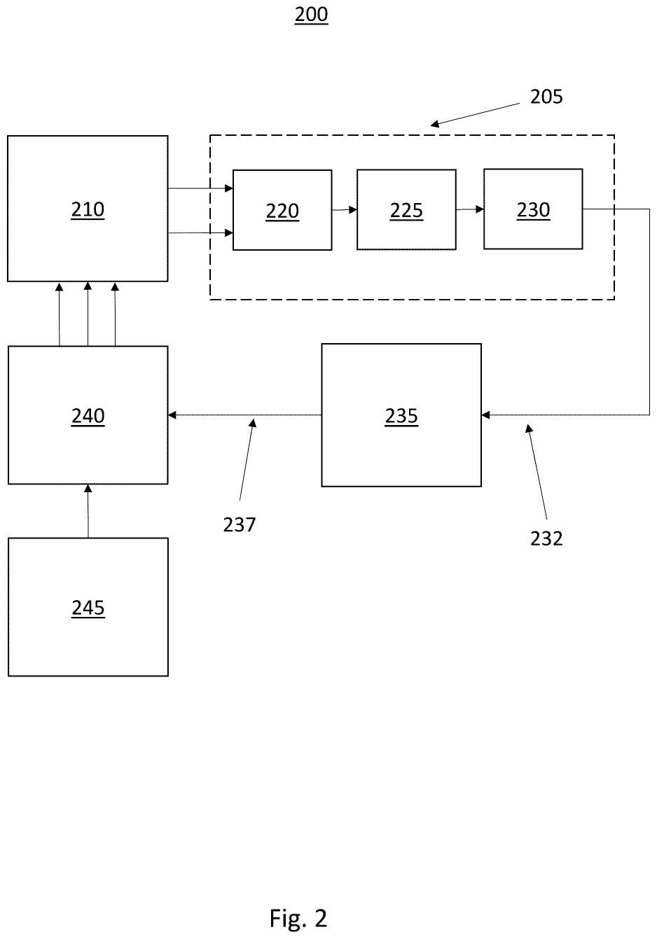

In various embodiments, the instructions of the autonomous driving system 70 may be organized by function, module, or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors. The computer vision system 74 includes an object detection module and the object detection system 200.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path. The positioning system 76 may process a variety of types of localization data in determining a location of the vehicle 10 including Inertial Measurement Unit data, Global Positioning System data, Real-Time Kinematic correction data, cellular and other wireless data, etc.

In various embodiments, the controller 34 implements machine learning techniques to assist the functionality of the controller 34, such as feature detection/classification, obstruction mitigation, route traversal, mapping, sensor integration, ground-truth determination, and the like. One such machine learning technique performs traffic object detection whereby traffic objects are identified, localized and optionally the status is determined for further processing by the guidance system 78. The machine learning technique may be implemented by a deep convolutional neural network. For example, a traffic control device (TCD), e.g. a traffic light, may be identified and localized and the light status determined. The feature detection and classification in two-dimensions (2D) may be performed by the object detection. Depending on the state of the traffic light (e.g. red for stop or green for go), the guidance system 78 and the vehicle control system 80 operate together to determine whether to stop or go at the traffic lights. The three-dimensional (3D) location of the TCD and other static traffic objects support localization of the vehicle 10 by the positioning system 76 such as lane alignment of the vehicle 10 and the TCD.

As mentioned briefly above, the static object detection system can be included within the automated driving system 70 in autonomous driving applications, for example in operable communication with the computer vision system 74, the positioning system 76, the guidance system 78 and the vehicle control system 80. The static object detection system 200 is configured to detect locations of static, dynamic, common and uncommon proximate objects and the vehicle control system 80 is responsive thereto to generate an automated control command. The vehicle control system 80 works with the actuator system 30 to traverse such a trajectory.

Turning now to FIG. 2, an exemplary electric vehicle (EV) drive system 200 is illustrated in accordance with exemplary embodiments. The EV drive system 200 can include an electric motor, a position processor 205, an inverter controller 235, an inverter 240, and a battery. The position processor 205 can include a synchronous frame filter 220, a high frequency filter 225 and a harmonic error decoupler 230.

The electric motor 210 is the primary actuator in the system. The motor converts electrical energy into mechanical energy, driving a load or performing a specific task. The motor's performance is influenced by factors such as voltage, current, and rotational speed. The inverter controller 235 is configured to regulate these parameters to achieve desired electric motor behavior. Typically an electric motor 210 comprises a rotor, a rotating component wound with copper wire, and a stator, a stationary component containing magnets or electromagnets. When an electric current is supplied to the rotor windings, it interacts with the magnetic field generated by the stator, resulting in a torque that rotates the rotor. This rotational motion is transmitted to the vehicle's wheels through a transmission system, enabling the vehicle to move.

In the EV drive system 200, the electric motor 210 is supplied with a three phase alternating current (AC) generated by the inverter 240. The inverter is typically configured with a plurality of high voltage switching transformers which are switched on and off in a regular sequence to convert a direct current (DC) current from the battery into the AC current. The switching rate and other inverter parameters are carefully regulated by the inverter controller 235 in response to a desired vehicle speed and direction. The inverter controller 235 can adjust the inverter parameters to optimize the electric motor's performance to meet the vehicle's driving demands, providing smooth and efficient acceleration, deceleration, and speed control.

To accurately control the electric motor 210, the inverter controller 235 requires knowledge of an electric motor's angular position. Accurate position information enables the controller to precisely calculate and apply the necessary voltage and current waveforms to the motor windings to ensure precise control over the motor's torque and speed. For high-speed applications, field-weakening techniques can be employed to maintain high power output without exceeding the motor's voltage limits. By knowing the motor's position, the controller can optimally adjust the excitation current to weaken the magnetic field, allowing for higher speeds while maintaining efficiency. Monitoring the motor's position can further aid in early detection of anomalies such as excessive vibration, misalignment, or mechanical damage, allowing the inverter controller 235 to initiate appropriate protective measures, such as reducing power or shutting down the motor, to prevent damage and ensure system reliability.

In some exemplary embodiments, the electric motor 210 can be configured with a resolver. Resolvers are rotary position sensors that generate two sinusoidal voltages, sine and cosine signals. These signals are 90 degrees out of phase with each other, and their amplitude and phase shift vary with the angular position of the resolver's shaft. By measuring the amplitude and phase difference between the two signals, the position processor 205 can determine the angular position of the motor shaft. The position processor 205 can transform the sine and cosine into a rotating reference frame, aligned with the synchronous speed of the motor. This transformation simplifies control and analysis by eliminating time-varying components. The filtering process removes unwanted high-frequency noise and disturbances from the signals, improving the accuracy of the control system.

Resolvers and electric motor position sensing in general is that the sine and cosine signals are often noisy and can include unwanted integer and non-integer position harmonics. The non-ideal signal properties can include signal offsets, signal scaling errors, such as amplitude imbalance on sine and cosine, imperfect orthogonality or quadrature error between sine and cosine of the sensor, additional multiple spatial harmonics, mechanical eccentricity and sensor low resolution noise. Some of these non-ideal signal properties can result from electromagnetic emission from the high power motor stator in the resolver.

Ideally, the raw sine and cosine signals provided by revolver to the position processor 205 would have the same amplitude, zero offset, and would be orthogonal, i.e., phase-shifted by exactly 90 degrees relative to each other. However, misalignment of sensors, electromagnetic interference and other factors can produce the types of position errors addressed herein. Left uncorrected, such errors may ultimately result in current ripple and torque ripple, thereby affecting control functionality within the EV drive system 200. To correct these sensor errors, the position processor 205 can employ a software-based solution for position measurement across various sensing technologies, including those with integrated digital signal processors (DSPs). By employing a synchronous frame filter 220, high frequency filter 225 and harmonic error decoupler 230, the position processor 205 can mitigate quantization noise and other non-ideal signal properties. In addition, the position processor 205 can leverage motion state filters to correlate errors with non-ideal harmonic properties, enabling real-time learning and adaptation to these errors.

The synchronous frame filter 220 is configured to receive the sine and cosine signals from the electric motor 210 to eliminate quantization and high frequency noise due to sampling in order to improve the accuracy and reliability of angle estimation. By transforming sinusoidal signals into stationary DC components, high-frequency noise can be effectively filtered out. The filtered DC signals are then converted back into sinusoidal waveforms, resulting in a smoother and more accurate representation of the original signal. This technique is particularly useful in applications where precise angle measurements are critical, as it mitigates the impact of noise and interference on the estimation process. Synchronous frame filtering is useful for mitigating the discrete jumps caused by the sampling process of lower sampling rate sensors.

The high frequency filter 225 is configured to filter the sine and cosine signals from the electric motor 210 to remove any remaining high-frequency components that might interfere with the control system. This filtering helps to improve the robustness and accuracy of the inverter controller 235, especially in the presence of electrical noise or other disturbances. The high frequency filter 225 can be a motion state filter having a low pass response and there by mitigating high frequency noise. An error term of motion state filter has a high pass filter response and thereby removes a DC component that helps for harmonic coefficients. This isolates the harmonic content, which is then subjected to Fourier integration. By extracting the Fourier coefficients (A and B), the filter reconstructs the harmonic signal using a dot product operation. This process is iteratively applied over time to decouple the harmonic component from the original signal. The high frequency filter 225 can be implemented in two configurations: high-bandwidth and low-bandwidth. The high-bandwidth filter attenuates high-frequency noise, while the low-bandwidth filter extracts the harmonic content for Fourier integration. By cascading these filters, the system can accurately estimate the harmonic components and improve the overall signal quality. Additional filtering can be applied to the position signal to further refine the estimation process.

The harmonic error decoupler 230 compensates for harmonic distortions in the motor's current and voltage waveforms. These distortions can degrade the performance of the motor and introduce unwanted vibrations. harmonic error decoupler 230 first identifies the dominant harmonic frequencies present in the signal. This can be done using techniques like Fourier analysis or spectral analysis. Once the harmonic frequencies are identified, the decoupler applies filters to attenuate or eliminate these frequencies. These filters can be designed to target specific frequency bands or specific harmonics. After filtering out the harmonic distortions, the angular position signal is reconstructed, which is now cleaner and less distorted.

The harmonic error decoupler 230 compensates for harmonic distortions present in the electric motor's 210 current and voltage waveforms. These distortions can adversely affect angular position detection. By utilizing techniques such as Fourier analysis, the harmonic error decoupler 230 identifies the dominant harmonic frequencies within the signal. Subsequently, it applies filters to attenuate or eliminate these frequencies, targeting specific frequency bands or individual harmonics. This filtering process results in a cleaner and less distorted angular position signal, enabling more precise and reliable motor control. The angular position signal is then coupled to the inverter controller 235 to be used to control the inverter 240 and electric motor 210.

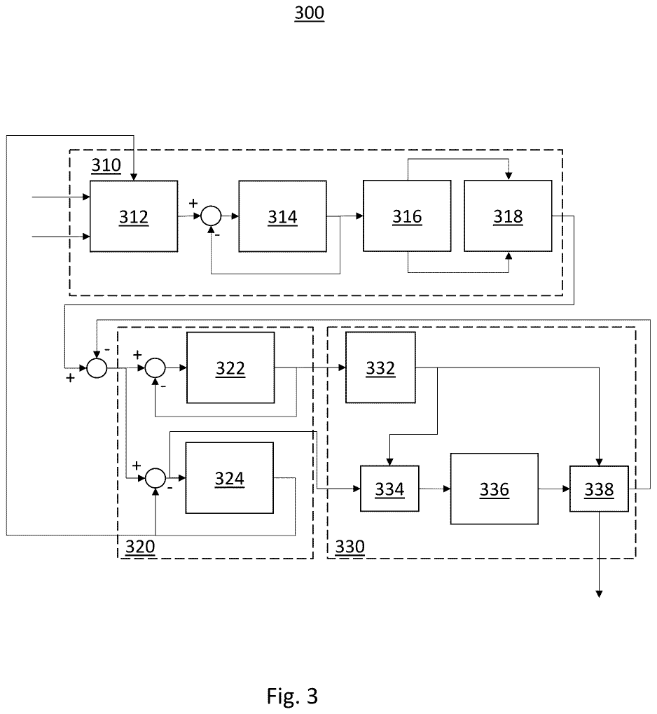

Turning now to FIG. 3, an exemplary block diagram of a position sensor 300 is shown indicative of the AC machine position sensor data processing method in accordance with exemplary embodiments. The position sensor 300 can include a synchronous frame filter 310, a motion state filter 320 and a harmonic error decoupler 330.

The synchronous frame filter 310 is a signal processing technique used to improve the accuracy and reliability of angle estimation. It works by transforming sinusoidal signals into stationary DC components, which can then be filtered to remove high-frequency noise. The filtered DC signals are then converted back into sinusoidal waveforms, resulting in a smoother and more accurate representation of the original signal.

The synchronous frame filter 310 receives two input signals: a sine wave (Sin) and a cosine wave (Cos) from the electric motor or other rotational device. These signals are typically obtained from sensors like resolvers or encoders. The input signals are multiplied by a complex exponential term, e^{(-jθ)} 312. This transformation shifts the frequency of the input signals to zero, effectively converting them into DC components. The DC components are then passed through a low-pass filter (K₁/s) 314 wherein K₁ is the fixed characteristic impedance value and S is the complex frequency variable used in Laplace transform analysis. This filter removes high-frequency noise and other unwanted components from the signal. The filtered DC signals are then multiplied by the complex exponential term e^{(jθ)} 316, which shifts their frequency back to the original frequency. This restores the sinusoidal waveforms. The filtered sine and cosine waves are output from the filter. These signals are now cleaner and less noisy than the original input signals. The filtered sine and cosine signals are used to calculate the angle using the arctangent function (atan2) 318. This improves quantization error due to low resolution and provides a more accurate estimate of the angle compared to using the original, noisy signals. By removing high-frequency noise, the synchronous frame filter 310 can significantly improve the accuracy of angle estimation. The filter is less sensitive to noise and interference, making it more robust in noisy environments. The filter improves the signal-to-noise ratio of the input signals, leading to clearer and more reliable measurements.

The filtered angle is next coupled to the motion state filter 320. The motion state filter 320 is first operative to generate two error signals, θ_err1 and θ_err2, which represent the difference between the estimated angle and the true angle. The high bandwidth motion state filter 322 processes the first error signal θ_err1 to extract high-frequency components of the angle error to generate a first observed rotational angle θ_obs1. θ_obs1 is then coupled to the harmonic error decoupler 330 and can also be coupled to a control system input. The low bandwidth motion state filter 324 processes the second error signal θ_err2 to extract low-frequency components of the angle error and to generate a second observed rotational angle θ_obs2. This filter is useful for capturing slow changes in the angle. The decoupler identifies and mitigates the effects of harmonic distortions in the signal by filtering out specific frequency components that are associated with harmonic distortions. This second observed rotational angle is then coupled back as an input to the synchronous frame filter 310. By combining synchronous frame filtering and motion state filtering with harmonic error decoupling, this system can achieve highly accurate and reliable angle estimation, even in challenging environments with noise and disturbances.

The harmonic error decoupler 330 is configured to receive the first observed rotational angle θ_obs1 from the high bandwidth motion state filter 322 and the second error signal θ_err2 from the motion state filter 320. Nth order harmonic error decoupling is a signal processing technique used to isolate and mitigate the effects of harmonic distortions in a signal. Harmonic distortions are unwanted frequency components that can arise from various sources, such as nonlinear components in electronic circuits or mechanical systems and errors such as offset, gain, and orthogonality on the sine and cosine waves also show up as harmonics. Harmonics on the sine and cosine waves can occur as harmonics errors on position. The harmonic error decoupler 330 first identifies the dominant harmonic frequencies present in the signal. This can be done using techniques like Fourier analysis or spectral analysis. Once the harmonic frequencies are identified, the harmonic error decoupler 330 applies filters to attenuate or eliminate these frequencies. These filters can be designed to target specific frequency bands or specific harmonics. After filtering out the harmonic distortions, the remaining signal is reconstructed, which is now cleaner and less distorted.

The complex exponential term e^{jnθ}332 is next configured to receive θ_obs1 from the high bandwidth motion state filter 322 and generate a harmonic signal at the nth frequency. This harmonic signal at the nth frequency is then coupled to the cross product block 334 and the dot product block 338. The cross product block 334 calculates the cross product between the second error signal θ_err2 and the harmonic signal at the nth frequency, to identify the phase and amplitude of the nth harmonic component. The amplitude of the nth harmonic component is then coupled to a low-pass filter to smooth out the estimated harmonic coefficients. This filtered nth harmonic component is then coupled to the dot product block 338 which calculates the dot product between the filtered nth harmonic component and the harmonic signal at the nth frequency from the complex exponential term e^{jnθ} 332, resulting in a signal that represents the position signal in the form Aₙcos(n [symbol] )+Bₙsin(n [symbol] ) . This position signal is then coupled to the inverter controller for use in controlling the electric motor and is also coupled back to the input of the motion state filter 320 for use in generating the two error signals, θ_err1 and θ_err2 which can result from non-ideal sensor behaviors, such as non-linearity, hysteresis, and temperature sensitivity.

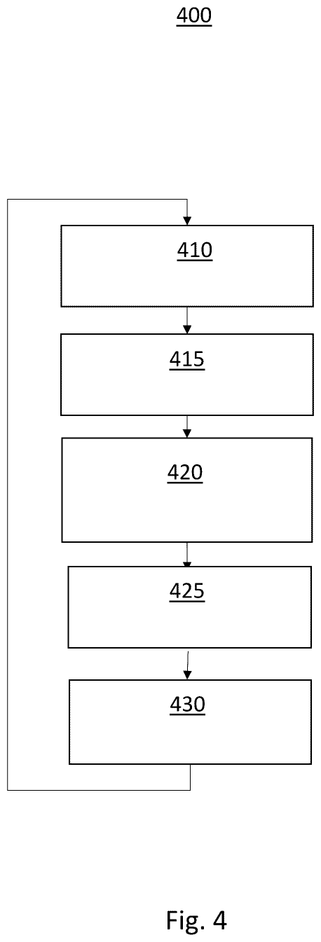

Continuing to refer to FIG. 4, a flow chart indicative of a method 400 for performing an AC machine position sensor data processing method in accordance with exemplary embodiments is shown. The method 400 is first operative to receive 410 the sine and cosine sensor signals from a rotational device. In some exemplary embodiments, the rotational device can be a three phase electric motor in an electric vehicle application, but the method can be applied equally to any application requirement measurement of angular position of a rotating object is required.

In response to receiving the sine and cosine signals, the method 400 next performs a synchronous frame filtering 415 on the sine and cosine signals to determine an angular position of the rotational device. Errors will be introduced in the angular position for various reasons such as error is offset, which manifests as a shift in the sine and cosine signals, resulting in a first harmonic distortion in the calculated position, gain errors, where the sine and cosine signals are not perfectly scaled, introduce second harmonic phase errors or orthogonality issues and/or errors in the position measurement which can contribute to second harmonic distortions. For example, sensor noise, another significant factor, can introduce various harmonics depending on the noise source. This noise can be inherent to the sensor itself, influenced by temperature variations, or affected by external systems like magnetic flux from motors. These harmonics can appear at different frequencies, such as the 5th, 7th, or higher harmonics, depending on the source.

To mitigate these errors, a two-pronged approach can be employed. The first component addresses under-sampled sensor signals by interpolating between sampling points. This interpolation technique, facilitated by a synchronous frame transformation, converts the sine and cosine signals into stationary DC components, filters them, and then rotates them back to obtain smoother, interpolated values. The second component focuses on harmonic error decoupling, acting as a filter to attenuate high-frequency quantization noise and specific harmonics.

Synchronous frame filtering 415 can be employed to determine rotational angle from noisy sine and cosine signals generated by a rotational sensor, such as a resolver. This method involves a transformation of the signals into a rotating reference frame, where they become stationary DC components. By filtering out high-frequency noise and disturbances, the DC components are cleaned up. Subsequently, the filtered signals are transformed back into the original stationary reference frame, yielding a smooth and accurate estimate of the rotational angle. This technique is particularly effective in dealing with low sampling rates and noisy environments, making it a valuable tool for precise position sensing in various applications.

In response to the rotational angle determined by the synchronous frame filtering 415, the method 400 is next operative to perform motion state filtering 420 on the received rotational angle. Motion state filtering 420 can be employed to enhance the accuracy of the received rotational angle, especially in the case of under-sampled signals by interpolating between discrete sensor measurements, generating a smoother and more continuous representation of the underlying motion. Motion state filtering utilizes a mathematical model that predicts the system's behavior between sampling points. The filter then combines these predicted values with the actual sensor measurements, resulting in a more precise estimate of the true motion state. This approach effectively mitigates the impact of noise and quantization errors commonly associated with under-sampled data, leading to improved position estimation and overall system performance.

In response to the refined rotational angle determined by the motion state filtering 415, the method 400 is next operative to perform harmonic error decoupling 430 on the refined rotational angle. Harmonic error decoupling 430 can be employed to enhance the precision of sensor data by mitigating high-frequency quantization noise and specific harmonic distortions. This method involves a transformation of the sinusoidal angular position signal, into a rotating reference frame. In this transformed frame, the harmonic components become stationary, enabling the application of low-pass filters to selectively attenuate unwanted frequencies. By judiciously selecting the filter cutoff frequency, both broadband noise and discrete harmonic disturbances are suppressed without compromising the essential information contained within the fundamental signal. Subsequently, the filtered signals are transformed back into the original reference frame, yielding a refined and more accurate representation of the underlying angular position signal.

The method 400 is next operative to control the inverter 430, using an inverter controller or the like, in response to the refined angular position. In an electric vehicle propulsion system, the inverter controller leverages the angular position signals measured by a resolver or a rotary sensor to precisely control the electric motor. The rotary sensor, provides analog signals representing the motor's rotational position and speed. The inverter controller processes these signals to determine the optimal phase and amplitude of the AC voltage applied to the motor's stator windings. By synchronizing the AC voltage with the motor's rotor position, the controller ensures efficient energy transfer and precise torque delivery. This enables smooth and controlled acceleration, deceleration, and precise speed regulation of the electric motor.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of determining an angular position of an electric motor comprising:
receiving, from a sensor, a first alternating current and a second alternating current sensed in response to a rotation of a rotor within the electric motor wherein the first alternating current is ninety degrees phase shifted from the second alternating current;
performing a synchronous frame filtering on the first alternating current and the second alternating current to generate a first angular position;
performing a motion state filtering on the first angular position to determine a first rotational angle and a second rotational angle;
performing a harmonic error decoupling on the first angular position in response to the first rotational angle and the second rotational angle to generate a refined angular position;
controlling an inverter to generate a three phase alternating current in response to the refined angular position;
controlling the electric motor in response to the three phase alternating current; and
propelling a vehicle along a motion path with the electric motor.

2. The method of determining the angular position of the electric motor of claim 1, wherein the motion state filtering is operative to interpolate between a plurality of discrete values of the first alternating current and the second alternating current to generate the first angular position.

3. The method of determining the angular position of the electric motor of claim 1, wherein the refined angular position forms a value in a refined first refined alternating current and a second refined alternating current and wherein the first refined alternating current and a second refined alternating current are supplied to an inverter controller for controlling the inverter to modify a characteristic of the three phase alternating current.

4. The method of determining the angular position of the electric motor of claim 1, wherein the harmonic error decoupling is configured to transform the first rotational angle and the second rotational angle to a rotating reference frame in order to mitigation a high-frequency quantization noise and a plurality of harmonic distortions.

5. The method of determining the angular position of the electric motor of claim 1, wherein the sensor is a resolver and wherein the first alternating current is a quantized value of a sine wave current and the second alternating current is a quantized value of a cosine wave current.

6. The method of determining the angular position of the electric motor of claim 1, wherein the synchronous frame filtering further includes reducing a frequency of the first alternating current to zero to obtain a first direct current (DC) value and reducing a frequency of the second alternating current to zero to obtain a second DC value and wherein the first DC value and the second DC value are passed through a low pass filter to remove a high frequency component from the first DC value to generate a first filtered DC value and a second filtered DC value and wherein the first angular position is determined in response to the first filtered DC value and the second filtered DC value.

7. The method of determining the angular position of the electric motor of claim 1, wherein the motion state filtering is further configured to detect a first angle error and a second angle error in response to the first angular position and to extract a high frequency component from the first angle error to generate the first rotational angle and to extract a low frequency component from the second angle error to generate the second rotational angle.

8. The method of determining the angular position of the electric motor of claim 1, wherein the motion state filtering is further configured to filter a plurality of harmonic distortions from the first angular position to determine the first rotational angle and the second rotational angle.

9. The method of determining the angular position of the electric motor of claim 1, wherein the second rotational angle is coupled back to the synchronous frame filtering and where the second rotational angle is used to generate a subsequent angular position in response to a subsequent first alternating current and a second subsequent alternating current.

10. A system for determining an angular position of a rotor within an electric motor comprising:
a sensor for generating a first alternating current (AC) current and a second AC current;
a position filter for performing a synchronous frame filtering on the first AC current and the second AC current to generate a first angular position, performing a motion state filtering on the first angular position to determine a first rotational angle and a second rotational angle, performing a harmonic error decoupling on the first angular position in response to the first rotational angle and the second rotational angle to generate a refined angular position;
an inverter controller for controlling an inverter to generate a three phase AC current in response to the refined angular position; and
the electric motor for propelling a vehicle in response to the three phase AC current.

11. The system for determining the angular position of the rotor within the electric motor of claim 10, wherein the refined angular position forms a value in a refined first refined AC current and a second refined AC current and wherein the first refined AC current and a second refined AC current are supplied to the inverter controller for controlling the inverter to modify a characteristic of the three phase AC current.

12. The system for determining the angular position of the rotor within the electric motor of claim 10, wherein the position filter is further configured to interpolate between a plurality of discrete values of the first AC current and the second AC current to generate the first angular position.

13. The system for determining the angular position of the rotor within the electric motor of claim 10, wherein the position filter is further configured to transform the first rotational angle and the second rotational angle to a rotating reference frame in order to mitigate a high-frequency quantization noise and a plurality of harmonic distortions.

14. The system for determining the angular position of the rotor within the electric motor of claim 10, wherein the sensor is a resolver and wherein the first AC current is a quantized value of a sine wave current and the second AC current is a quantized value of a cosine wave current and wherein the first AC current and the second AC current are generated in response to a rotation of the rotor.

15. The system for determining the angular position of the rotor within the electric motor of claim 10, wherein the position filter is further configured for reducing a frequency of the first AC current to zero to obtain a first direct current (DC) value and reducing a frequency of the second alternating current to zero to obtain a second DC value and wherein the first DC value and the second DC value are passed through a low pass filter to remove a high frequency component from the first DC value to generate a first filtered DC value and a second filtered DC value and wherein the first angular position is determined in response to the first filtered DC value and the second filtered DC value.

16. The system for determining the angular position of the rotor within the electric motor of claim 10, wherein the position filter is further configured to detect a first angle error and a second angle error in response to the first angular position and to extract a high frequency component from the first angle error to generate the first rotational angle and to extract a low frequency component from the second angle error to generate the second rotational angle.

17. The system for determining the angular position of the rotor within the electric motor of claim 10, wherein the position filter is further configured to filter a plurality of harmonic distortions from the first angular position to determine the first rotational angle and the second rotational angle.

18. The system for determining the angular position of the rotor within the electric motor of claim 10, wherein the second rotational angle is used to generate a subsequent angular position in response to a subsequent first AC current and a second subsequent AC current in response to a subsequent synchronous frame filtering.

19. An electric vehicle propulsion system comprising:
a battery for supplying a direct current (DC) current;
an inverter for converting the DC current to a three phase alternating current (AC) current in response to an inverter control signal;
an electric motor for rotating a rotor within the electric motor in response to the three phase AC current;
a resolver for generating a first AC current and a second AC current in response to a rotation of the rotor;
a position sensor for performing a synchronous frame filtering on the first AC current and the second AC current to generate a first angular position, performing a motion state filtering on the first angular position to determine a first rotational angle and a second rotational angle, performing a harmonic error decoupling on the first angular position in response to the first rotational angle and the second rotational angle to generate a refined angular position; and
an inverter controller for generating the inverter control signal in response to the refined angular position.

20. The electric vehicle propulsion system of claim 19 wherein the synchronous frame filtering further includes reducing a frequency of the first AC current to zero to obtain a first DC value and reducing a frequency of the second AC current to zero to obtain a second DC value and wherein the first DC value and the second DC value are passed through a low pass filter to remove a first high frequency component from the first DC value to generate a first filtered DC value and a second filtered DC value and wherein the first angular position is determined in response to the first filtered DC value and the second filtered DC value and wherein the motion state filtering is further configured to detect a first angle error and a second angle error in response to the first angular position and to extract a second high frequency component from the first angle error to generate the first rotational angle and to extract a low frequency component from the second angle error to generate the second rotational angle and, wherein the harmonic error decoupling is configured to transform the first rotational angle and the second rotational angle to a rotating reference frame in order to mitigation a high-frequency quantization noise and a plurality of harmonic distortions.
